(19) United States
(12) Patent Application Publication
(10) Pub. No.: US 2026/0286889 A1
(43) Pub. Date: Sep. 24, 2026

(54) PROPULSION SYSTEM ARCHITECTURE COMPRISING AN UNDUCTED FAN AND A DUCTED FAN

(71) Applicant: Safran Aircraft Engines, PARIS (FR)

(72) Inventors: Maxime Paul Numa GIVERT, MOISSY-CRAMAYEL (FR); Julien Fabien Patrick BECOULET, MOISSY-CRAMAYEL (FR); Olivier BELMONTE, MOISSY-CRAMAYEL (FR)

(73) Assignee: Safran Aircraft Engines, PARIS (FR)

(21) Appl. No.: 19/474,295

(22) PCT Filed: Apr. 11, 2023
(86) PCT No.: PCT/IB2023/000481

§ 371 Date: Oct. 10, 2025

(51) Int. Cl. F02C 7/06; B64D 27/10; B64D 27/40

(52) U.S. Cl. CPC F02C 7/06; B64D 27/10; B64D 27/402; F05D 2220/36; F05D 2240/50

(57) ABSTRACT

The disclosure concerns an open rotor propulsion system (10) comprising: an unducted fan (20); an inlet duct (71); a ducted fan (40) positioned behind the unducted fan (20) within the inlet duct (71); an engine positioned aft of the inlet duct (71) comprising a shaft (25) connecting a fan drive turbine (60) and the ducted fan (40); and bearings configured to support the shaft (25) with respect to an engine case (49), wherein the bearings comprise a double-ball bearing (61) connected to one of the forward frame (78) and the intermediate case (51).

### TECHNICAL FIELD

The technology described herein relates to open rotor and ducted propulsion systems, and particularly architectures for such systems. The technology is of particular benefit when applied to gas turbine engines for aircraft propulsion.

### BACKGROUND

Gas turbine engines employing an open rotor design architecture are known. A turbofan engine operates on the principle that a central gas turbine core drives a bypass fan, the fan being located at a radial location within a nacelle of the engine and upstream of the engine core such that the fan operates within a “duct” formed by the inner surface of the nacelle but air driven by the fan “bypasses” the central gas turbine core. An open rotor propulsion system instead operates on the principle of having the bypass fan located outside of the engine nacelle, in other words, “unducted”. This permits the use of larger fan blades able to act upon a larger volume of air than for a turbofan engine, and thereby improves propulsive efficiency over conventional ducted engine designs.

Optimum performance has been found with an open rotor design having a fan provided by two contra-rotating rotor assemblies, each rotor assembly carrying an array of airfoil blades located outside the engine nacelle. As used herein, “contra-rotational relationship” means that the blades of the first and second rotor assemblies are arranged to rotate in opposing directions to each other. Typically, the blades of the first and second rotor assemblies are arranged to rotate about a common axis in opposing directions, and are axially spaced apart along that axis. For example, the respective blades of the first rotor assembly and second rotor assembly may be co-axially mounted and spaced apart, with the blades of the first rotor assembly configured to rotate clockwise about the axis and the blades of the second rotor assembly configured to rotate counter-clockwise about the axis (or vice versa). In appearance, the fan blades of an open rotor engine resemble the propeller blades of a conventional turboprop engine.

In order to reduce the complexity of the design, yet yield a level of propulsive efficiency comparable to contra-rotating propulsion designs with a significant weight and length reduction, document US 2021/0108597 proposes a propulsion system comprising a fan section including a rotating element and a stationary element, and an inlet between the rotating element and the stationary element, wherein the inlet passes radially inward of the stationary element. The inlet leads to an inlet duct containing a ducted fan having an axis of rotation and a plurality of blades. Besides, the inlet duct divides into a first duct and a second duct, separate from the first duct. The rotating element of the fan section is driven by a fan drive turbine section through a fan drive shaft.

However, the ducted fan is massive with a large diameter and is subject to external aggressions. It may therefore be unbalanced.

Besides, Applicant discovered that the fan drive turbine shaft of this propulsion system was supercritical. Indeed, the fan drive turbine shaft has at least one flexural mode in its operating range and may resonate during stabilized flight phases. In some cases, the flexural mode of the fan drive turbine shaft may even coincide and couple with a flexural mode of the unbalanced ducted fan (radial translation of the blades of the ducted fan). Besides, in some cases, the stator parts of the propulsion system may contribute to the flexural mode of the fan drive turbine shaft.

### SUMMURAY

An objective of the disclosure is the provision of a propulsion system comprising a fan section including an open rotating element and a ducted fan, having an improved dynamic response in stabilized flight phases, and more particularly wherein the energetic contribution of the ducted fan to the fan drive turbine shaft and the amount of potential energy in the fan drive turbine shaft are reduced.

In that purpose, the disclosure proposes according to a first aspect an open rotor propulsion system comprising:
a fan section including an unducted rotating element comprising a first array of fan airfoil blades and a non-rotating stationary element;
a forward frame housing an inlet duct including an inlet located between the unducted rotating element and the non-rotating stationary element;
a ducted fan positioned aft the unducted rotating element within the inlet duct, wherein the ducted fan comprises a second array of fan airfoil blades;
a fan duct and a core duct extending aft the ducted fan;
an engine positioned within the core duct and comprising a low-pressure compressor, a high-pressure compressor, an intermediate case located between the low-pressure compressor and the high-pressure compressor, a fan drive turbine and a shaft connected to the fan drive turbine and configured to drive the ducted fan; and
bearings configured to support the shaft with respect to an engine case, wherein the bearings comprise a double-ball bearing connected to one of the forward frame and the intermediate case.

Preferred but non-limiting embodiments of the open rotor propulsion system according to the first aspect are the following:
the double-ball bearing is positioned radially inwardly of the ducted fan;
the double-ball bearing is connected to the forward frame;
a gravity center of the double-ball bearing is axially positioned between a first plane that intersects a forwardmost point of a leading edge of the unducted fan and a second plane that intersects a downwardmost point of a trailing edge of the unducted fan;
the double-ball bearing comprises a forward ball bearing and a downward ball bearing, gravity centers of the forward ball bearing and the forward ball bearing being both axially positioned between the first plane and the second plane;
the double-ball bearing is connected to the intermediate case;
the double-ball bearing is downward of the ducted fan;
a gravity center of the double-ball bearing is axially positioned between a third plane that intersects a forwardmost point of a leading edge of a forwardmost rotor blade of the low-pressure compressor and a fourth plane that intersects a downwardmost point of a trailing edge of a downwardmost rotor blade of the low-pressure compressor;
the double-ball bearing comprises a forward ball bearing and a downward ball bearing, gravity centers of the forward ball bearing and the forward ball bearing being both axially positioned between the third plane and the fourth plane;
the double-ball bearing comprises two ball bearings axially offset by at most 300 mm, for example at most 100 mm; and/or
the open rotor propulsion system further comprises only the double-ball bearing between a first plane that intersects a forwardmost point of a leading edge of the unducted fan and a fourth plane that intersects a downwardmost point of a trailing edge of a downwardmost rotor blade of the low-pressure compressor.

According to a second aspect, it is proposed an aircraft comprising at least one open rotor propulsion system according to the first aspect, wherein the open rotor propulsion system is connected to the aircraft via a pylon.

The present disclosure applies for example to propulsion systems having a redline (maximum speed that can be reached by the propulsion system) between 8,000 rpm and 15,000 rpm, for example of about 10,000 rpm.

### BRIEF DESCRIPTION OF THE DRAWINGS

Other features, objects, and advantages of the present disclosure will appear on reading the following detailed description and from the accompanying drawing, given by way of non-limiting example, and in which:

FIG. 1 is a cross-sectional schematic illustration of an exemplary embodiment of an open rotor propulsion system;

FIG. 2 represents an exemplary aircraft comprising open rotor propulsion systems;

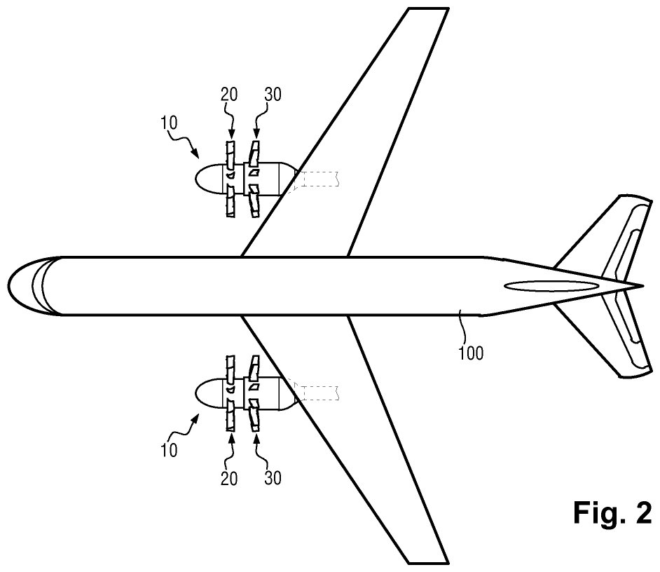

FIG. 3a is a schematic illustration of the ducted fan, wherein an exemplary configuration in accordance with a first embodiment of the double-ball bearing of the fan drive turbine shaft has been represented;

FIG. 3b is a schematic illustration of the ducted fan, wherein an exemplary configuration in accordance with a second embodiment of the double-ball bearing of the fan drive turbine shaft has been represented;

FIG. 4 is a diagram that represents the clearance closures (in meters) under maneuvers and ducted fan unbalance as a function of rotational speed (in rounds per minute) of the flexural mode of a ducted fan that is supported by conventional bearings, here two bearings distant by more than 100 mm (C1 curve); of a ducted fan according to a first variant, wherein the ducted fan is straddle mounted between a double-ball bearing and an additional bearing (C2 curve); and of a ducted fan according to a second variant, wherein the ducted fan is only supported by the double-ball bearing and is not straddle mounted (C3 curve); and

FIG. 5 is a schematic illustration of an example of an open rotor propulsion system fixed to the pylon of an aircraft according to an embodiment.

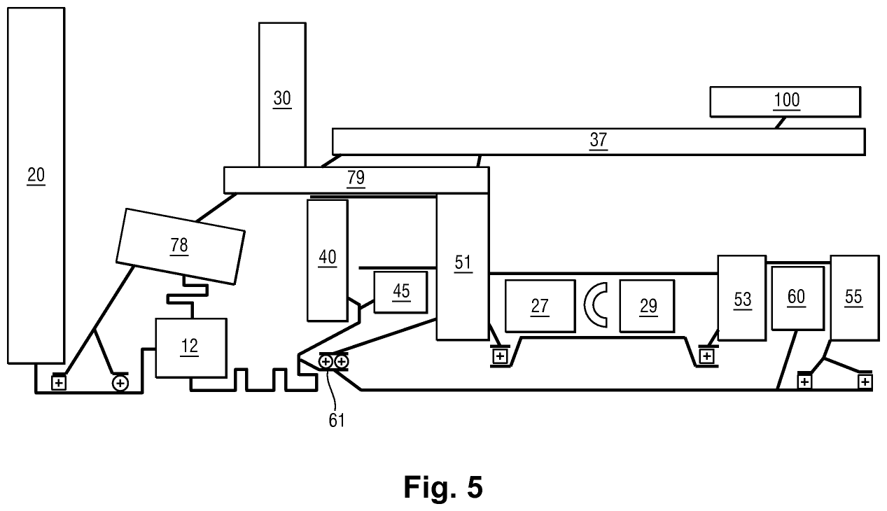

Like designations in the drawings and descriptions have been used to refer to like parts of the disclosure.

### DETAILED DESCRIPTION

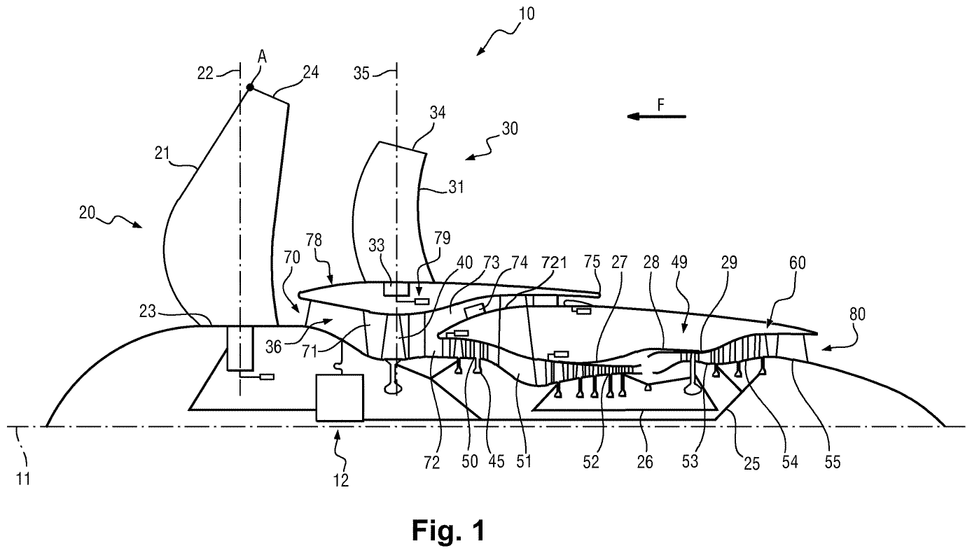

FIG. 1 shows an elevational cross-sectional view of an exemplary embodiment of an open rotor propulsion system 10 for example for propulsion of an aircraft 100. As is seen from FIG. 1, the open rotor propulsion system 10 comprises a fan section including a rotating element 20 which includes an array of fan airfoil blades 21 around a central longitudinal axis 11 of the open rotor propulsion system 10. Blades 21 are arranged in typically equally spaced relation around the centerline 11, and each blade 21 has a root 23 and a tip 24, and a span defined therebetween, as well as a central blade axis 22. Open rotor propulsion system 10 includes a gas turbine engine having a low-pressure (LP) compressor 45, or booster, a gas turbine core and a low-pressure (LP) turbine 60. Gas turbine core includes a high-pressure (HP) compressor 27, a combustor 28, and a high-pressure (HP) turbine 29 in serial flow relationship. A high-pressure (HP) shaft 26 enables the HP turbine 29 to drive the HP compressor 27. A low-pressure (LP) shaft 25 enables the LP turbine 60 to drive the rotating element 20 and the booster 45.

In the present application, upstream and downstream are defined with respect to the normal flow direction of gas through the propulsion system 10. Furthermore, the axial direction corresponds to the direction of the longitudinal axis 11, and a radial direction is a direction perpendicular to this axis 11 and passing through it. Internal and external will be used, respectively, in reference to a radial direction so that the internal part or face of an element is closer to the axis 11 than the external part or face of the same element. Finally, the planes defined herein below are all normal to the longitudinal axis 11.

The fan section of the open rotor propulsion system 10 also includes, in the exemplary embodiment of FIG. 1, a non-rotating stationary element 30 which includes an array of vanes 31 also disposed around central axis 11, and each vane 31 has a root 33 and a tip 34 and a span defined therebetween. These vanes 31 may be arranged such that they are not all equidistant from the rotating assembly, and be unshrouded (as shown in FIG. 1) or may optionally include an annular shroud or duct distally from axis 11 (axis 11 is shown in FIG. 1). These vanes are mounted to a stationary frame and do not rotate relative to the central axis 11, but may include a mechanism for adjusting their orientation relative to their axis 35 and/or relative to the blades 21. For reference purposes, FIG. 1 also depicts a forward direction denoted with arrow F, which in turn defines the forward and aft portions of the system. As shown in FIG. 1, the rotating element 20 is located forward of the gas turbine core in a “puller” configuration, and the exhaust 80 is located aft of the stationary element 30.

Open rotor propulsion system 10 may also include a power gearbox 12 which may include a gearset for decreasing the rotational speed of the rotating element 20 relative to the low-pressure turbine 60. The blades 21 of the open, unducted rotating element 20 may have a fixed pitch or blade angle, or may instead have a variable pitch or blade angle to vary thrust and blade loading during operation and, in some configurations, to provide a reverse thrust configuration for aircraft deceleration upon landing.

An annular 360 degrees inlet 70 is located between the rotating element 20 and the fixed or stationary element 30, and comprises a vane 36 that receives a path for incoming atmospheric air to enter the gas turbine core radially inwardly of the stationary element 30. Such a location may be advantageous for a variety of reasons, including management of icing performance as well as protecting the inlet 70 from various objects and materials as may be encountered in operation.

FIG. 1 illustrates what may be termed a “puller” configuration where the thrust-generating rotating element 20 is located forward of the gas turbine core. Other configurations are possible and contemplated as within the scope of the present disclosure, such as what may be termed a “pusher” configuration embodiment where the gas turbine core is located forward of the rotating element 20. A variety of architectures are shown and described in the publications number WO 2022/069834, WO 2022/018380 and US 2013/0098066 for example.

In addition to the open rotor or unducted rotating element 20 with its plurality of fan airfoil blades 21, a ducted fan 40 is included behind the open rotor rotating element 20, such that the open rotor propulsion system 10 includes both a ducted and an unducted fan which both serve to generate thrust through the movement of air at atmospheric temperature without passage through the gas turbine core. The ducted fan 40 is shown at about the same axial location as vanes 31, and radially inward of the vane roots 33. Alternatively, the ducted fan 40 may be between the vane 31 and core duct 72, or be farther forward of the vanes 31. The ducted fan 40 may be driven by the low-pressure turbine 60, or by any other suitable source of rotation, and may serve as the first stage of booster 45 or may be operated separately.

The ducted fan 40 includes an array of fan airfoil blades 41 around the central longitudinal axis 11 of the open rotor propulsion system 10. Blades 41 are arranged in typically equally spaced relation around the centerline 11, and each blade 41 has a root 43 and a tip 44, and a span defined therebetween.

In the following, the invention will be described in reference to a ducted fan 40 driven by the low-pressure turbine 60. Besides, this same low-pressure turbine 60 drives the unducted rotating element through the gearbox 12. However, in an embodiment, the unducted rotating element 20 may be driven by any other suitable source of rotation.

Air entering the inlet of the gas turbine core flows through an inlet duct 71 and then is divided behind the ducted fan 40 such that a portion flows through a core duct 72 and a portion flows through a fan duct 73. Fan duct 73 may incorporate heat exchangers 74, and exhausts to the atmosphere through an independent fixed or variable nozzle 75 aft of the stationary element 30 and outside of the gas generator core cowl 76. Air flowing through the fan duct 73 thus “bypasses” the core of the engine and does not pass through the core. Open rotor propulsion system 10 therefore includes an unducted fan formed by rotating element 20, followed by a ducted fan 40, which directs airflow into two concentric or non-concentric ducts 72 and 73, thereby forming a three-stream engine architecture with three paths for air which passes through the rotating element 20.

Since the open rotor propulsion system 10 includes both an open rotor rotating assembly 20 and a ducted fan assembly 40, the thrust output of both and the work split between them can be tailored to achieve specific thrust, fuel burn, thermal management, and acoustic signature objectives which may be superior to those of a typical ducted fan gas turbine propulsion assembly of comparable thrust class. The ducted fan assembly 40, by lessening the proportion of the thrust required to be provided by the unducted fan assembly 20, may permit a reduction in the overall fan diameter of the unducted fan assembly and thereby provide for installation flexibility and reduced weight.

Operationally, the open rotor propulsion system 10 may include a control system that manages the loading of the respective open and ducted fans, as well as potentially the exit area of the variable fan nozzle, to provide different thrust, noise, cooling capacity and other performance characteristics for various portions of the flight envelope and various operational conditions associated with aircraft operation. For example, in climb mode the ducted fan may operate at maximum pressure ratio thereby maximizing the thrust capability of stream, while in cruise mode, the ducted fan may operate at a lower pressure ratio, raising overall efficiency through reliance on thrust from the unducted fan. Nozzle actuation modulates the ducted fan operating line and overall engine fan pressure ratio independent of total engine airflow.

The open rotor propulsion system 10 comprises an engine case 49 housing the gas turbine engine aft of the ducted fan 40. The engine case 49 includes a forward frame 78 that extends immediately aft of the unducted fan 20, at the level of the inlet 70. More particularly, the forward frame 78 extends between the unducted fan 20 and the ducted fan 20 and comprises the vane 36 that faces the path for incoming atmospheric air to enter the gas turbine core radially inwardly of the stationary element 30. The inlet duct 71 is therefore housed within the forward frame 78. The forward frame 78 is a structural part of the propulsion system 10 and is supported by bearings of the unducted fan 20. In an embodiment, the gearbox 12 may be connected to the forward frame 78, optionally hung to the forward case.

The engine case 49 also includes an OGV case 78 (for Open Guide Vane case), aft of the forward frame 78, which receives the ducted fan 40. The OGV case 789 is a structural case that supports the stationary element 30. It may be noted that the fan duct 73 is incorporated into the OGV case 79.

The engine case 79 also includes a booster case 50 that houses the booster 45, an intermediate case 51, a high-pressure case 52 that houses the gas turbine core, an inter-turbine case 53, a turbine case 54 and a turbine rear frame 55, in serial flow relationship. The intermediate case 51 (or mid-frame) extends between the booster case 50 and the high-pressure case 52 and is supported by bearing(s) of the LP shaft 25. The intermediate case 51 is also a structural case of the propulsion system 10. In an embodiment, the OGV case is configured to be connected to the pylon 37 of an aircraft 100 and is structurally supported by the intermediate case 51.

It may be noted here that, in the present application, a “structural” is used to define a case or a frame of the engine, which is configured to transfer loads of the propulsion system 10. In other words, a structural frame or case is a case through which axial and radial forces of the propulsion system 10 transit (such as the loads of the bearings supporting the shafts transiting through the structural case towards suspension of the engine, such as the pylon 37). As aforementioned, the forward frame 78, the OGV case 79 and the intermediate case 51 are structural cases. The forward frame 78 is configured to receive the thrust forces generated by the unducted fan 20 and transmit them to the airplane through the pylon 37. The intermediate case 51 is configured to receive the thrust forces generated by the ducted fan 40 and transmit them to the airplane through the OGV case and the pylon 37. In contrast, the booster case 50 and the high-pressure case 52 support the corresponding compressor sections and delimit the flow path within said compressor sections; however, these cases 50, 52 are not structural cases in the meaning of the present application.

The LP shaft 25 is connected to the engine case 49 of the gas turbine engine via bearings, including forward bearing(s) configured to support the front portion of the shaft 25 and rear bearing(s) configured to support the rear portion of the shaft 25.

As aforementioned, the LP shaft 25 is connected to and driven by the LP turbine rotor 60 and drives the booster 45, the ducted fan 40 and the unducted fan 20. Optionally, propulsion system 10 may include an additional shaft, that connects the LP shaft 25 to the ducted fan 40.

The forward bearing(s) include a double-ball bearing 61 that supports the front portion of the shaft 25. The double-ball bearing 61 is connected to one of the forward frame 78 and the intermediate case 51 and is positioned under the ducted fan 40. The double-ball bearing 61 helps controlling the LP shaft mode location and the LP shaft 25 stability and clearance closure regarding the HP rotor 26.

A double-ball bearing is a bearing comprising a first ball bearing and a second ball bearing, which are pre-loaded and sufficiently close to provide a dynamic response that corresponds to the dynamic response of a single bearing. In that purpose, the first and second ball bearings are axially offset by at most 200 mm, preferably at most 100 mm, for example between 10 mm and 50 mm or between 10 mm and 50 mm and are axially aligned such that the first bearing is forward of the second bearing. The behavior of a double-ball bearing is improved, compared to the behavior of a single ball bearing. Besides, a single support connects the outer rings of the first and second ball bearings of the double-ball bearing 61. In that purpose, the support 64 may include an annular, integral flange, which is connected to the outer rings 62 of the first and second ball bearings of the double-ball bearing 61, and a connecting flange that fixes the annular flange to the engine case 49. The connecting flange may have a truncated shape.

The first and second ball bearings form two rows of balls, which may be preloaded. It may be noted that the dynamic behaviour of a double-ball bearing is better that the better dynamic of a single ball bearing.

This structural configuration of the double-ball bearing 61 decouples the flexural mode of the LP shaft 25 from the suspension modes of the ducted fan 40. Indeed, a double-ball bearing has an inherent stiffness in rotation that allows decoupling of the flexural mode of the LP shaft 25 from the flexural mode of the ducted fan 40.

The inherent stiffness in rotation corresponds here to the stiffness of the double-ball bearing 61 when a torque is applied to the double-ball bearing 61 about the central longitudinal axis 11. It can be noted that the inherent stiffness in rotation of the double-ball bearing 61 is defined intrinsically, that is to say by considering the double-ball bearing 61 as such, outside the propulsion system 10. The inherent stiffnesses values are therefore absolute values, not relative values, and do not depend on the environment in which they are measured, such that it is possible to integrate the double-ball bearing 61 in any propulsion system 10. The inherent stiffness in rotation of the double-ball bearing 61 may be determined by encasing an end of the double-ball bearing 61, the other end being free to rotationally move. This configuration actually reflects the configuration of the double-ball bearing 61 in the propulsion system 10 (the encased end corresponding to the outer rings 62 of the double-ball bearing 61, which are connected to the engine case 49 and the free end corresponding to the inner rings 62 of the double-ball bearing 61, which are connected to the LP shaft 25). The stiffness of the double-ball bearing 61 is then defined as the ratio between the angular displacement of the free end with respect to the encased end that results from a torque applied to the free end (over turning moment).

A relative difference between the first flexural mode of the LP shaft 25 and the first flexural mode of the ducted fan 40 may then be between 10% and 20%. The LP shaft 25 is therefore less sensitive to imbalance of the ducted fan 40 and deformations of the LP shaft 25 (more particularly, the maximum bending of the LP shaft 25 located at the level of the HP compressor) are reduced. Besides, due to the location of the double-ball bearing 61 adjacent the ducted fan 40, static clearance (resulting from gravity and rotation of the LP shaft 25) will be improved.

Such an inherent stiffness in rotation of the double-ball bearing 61 may also stiffen the path of the loads applied by the rotating parts to the engine case 49 and moves the first flexural modes of the LP shaft 25 to a transitional, unstable flight phase (such as the climb phase) or outside the operational speeds. The double-ball bearing 61 therefore helps controlling the ducted fan suspension mode and clearance closures under maneuvers and ducted fan unbalance. With a double-ball bearing 61, the clearance closures may for example be less than 7 mm, preferably less than 5 mm.

The inherent stiffness in non-zero rotation of the double-ball bearing 61 may be for example greater than or equal to 0.5×10⁻⁹ rad/N·m and less than or equal to 200×10⁻⁹ rad/N·m when the propulsion system is operating.

It may be noted that the position of the double-ball bearing 61 allows deformation of the forward portion of the propulsion system 10. Indeed, in operation, the unducted fan 20 pulls on the forward frame 78 and the intermediate case 51 and generates a relative movement between the unducted fan 20 and the stationary element 30 that creates clearances. By positioning the double-ball bearing 61 adjacent the unducted fan 40 and by connecting the double-ball bearing 61 to one of the forward frame 78 and the intermediate case 51, the support 64 that connects the double-ball bearing 61 to the engine case 49 follows the stationary element 30 and reduces the forward part clearances.

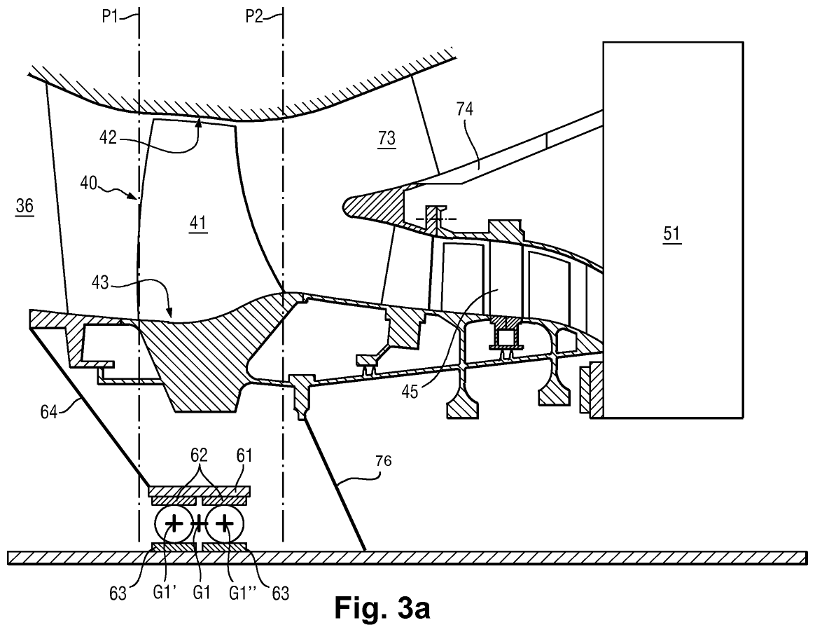

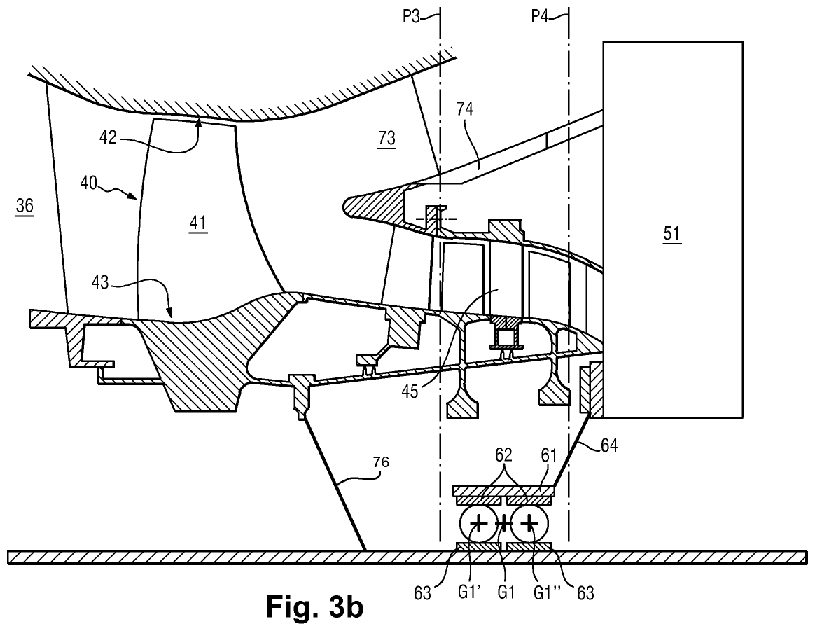

In a first embodiment, which is illustrated in FIG. 3a, the double-ball bearing 61 is positioned radially inwardly of the ducted fan 40 and is connected to the forward frame 78.

A gravity center G1 of the double-ball bearing 61 may be axially positioned between a first plane P1 that intersects a forwardmost point of a leading edge of the unducted fan 40 and a second plane P2 that intersects a downwardmost point of a trailing edge of the unducted fan 40. The leading edge extends opposite the gas flow entering the ducted fan 40. It corresponds to the front part of the fan airfoil blades 41 which faces the gas flow and which divides the gas flow into a pressure flow and a suction flow. The trailing edge corresponds to the rear part of the fan airfoil blades 41, where the pressure and suction flows meet.

It can be noted here that only the double-ball bearing 61 as such (including the inner and outer rings 62, 63) is taken into account to determine the gravity center of the bearing. The support 64 that connects the outer rings 62 of the double-ball bearing 61 to the engine case 49 is therefore not part of the bearing 61 as such.

To make sure that the LP shaft mode remains in a non-stabilized speed range (for resonance crossing the mode), the double-ball bearing 61 should be positioned such that its gravity center G1 is axially positioned between the first and second planes P1, P2. Position of the double-ball bearing 61 within this axial range may then be optimized for stability and resonance (depending for each similar architecture on parts weight, inertia, stiffness, etc.). Preferably, the gravity centers G1′ and G1″ of the first and second ball bearings of the double-ball bearing 61, respectively, are both axially positioned between the first plane P1 and the second plane P2. Here again, only the first ball bearing (resp. the second ball bearing) as such (including the inner and outer rings 62, 63) is taken into account to determine the gravity center of the bearing.

The support 64 of the double-ball bearing 61 comprises the annular flange and the connecting flange, which has a truncated shape and extends forwardly from the outer rings 62 of the double-ball bearing 61 towards the forward frame 78.

In a second embodiment, which is illustrated in FIG. 3b, the double-ball bearing 61 is positioned downward of the ducted fan 40 and is connected to the intermediate case 50. The double-ball bearing 61 may be connected to the front portion of the intermediate case 51, that is to say to the front connecting flange of the intermediate case 51, which is connected to the rear portion of the booster case 50.

The gravity center G1 of the double-ball bearing 61 may then be axially positioned between a third plane P3 that intersects a forwardmost point of a leading edge of a forwardmost rotor blade of the low-pressure compressor 45 and a fourth plane P4 that intersects a downwardmost point of a trailing edge of a downwardmost rotor blade of the low-pressure compressor 45.

Here again, to make sure that the LP shaft mode remains in a non-stabilized speed range (for resonance crossing the mode), the double-ball bearing 61 should be positioned such that its gravity center G1 is axially positioned between the third and fourth planes P3, P4. Position of the double-ball bearing 61 within this axial range may then be optimized for stability and resonance (depending for each similar architecture on parts weight, inertia, stiffness, etc.). Preferably, the gravity centers G1′ and G1″ of the first and second ball-bearings of the double-ball bearing 61, respectively, are both axially positioned between the third plane P3 and the fourth plane P4.

The support of the double-ball bearing 61 comprises the annular flange and the connecting flange, which has a truncated shape and extends rearwardly from the outer rings 62 of the double-ball bearing 61 towards the intermediate case 50.

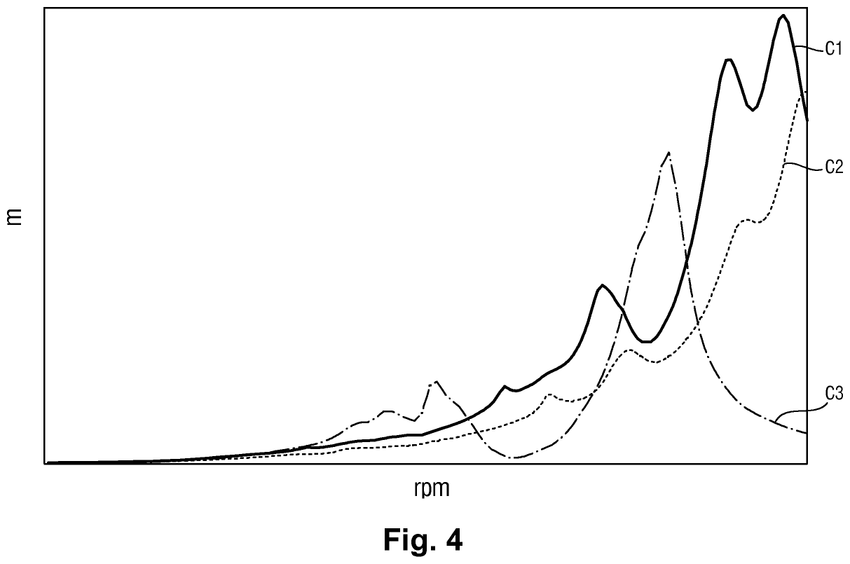

The ducted fan could be straddle mounted between the double-ball bearing 61 and an additional bearing, which may include a roller bearing (not shown). One of the double-ball bearing 61 and the additional bearing is therefore positioned upstream of the duct fan 40 while the other of the double-ball bearing 61 and the additional bearing is positioned downstream of the ducted fan 40. This configuration already improves the dynamic behavior and stiffness in rotation of the bearings that support the ducted fan 40 (curve C2), compared to the conventional mounting of a fan (curve C1), as can be seen in FIG. 4. Indeed, the clearance closures are smaller with a double-ball bearing 61 that in a conventional configuration (curve C1), wherein the mid-fan is only supported by simple bearings in a straddle configuration.

Alternatively, the bearings of the LP shaft 25 only comprises the double-ball bearing 61 between the first plane P1 and the fourth plane P4. In other words, the ducted fan 40 is not straddle mounted between two bearings and is only supported by the LP shaft 25 through the double-ball bearing 61. As can be seen in FIG. 4, this configuration further improves decoupling of the first flexural modes of the LP shaft 25 from the suspension modes of the ducted fan 40 (see curve C3).

Optionally, the double-ball bearing 61 may include a soft squirrel cage and a squeeze-film damper to significantly reduce the impact of the first flexural mode of the LP shaft on the architecture by damping the loads applied to the double-ball bearing 61 and limiting clearance consumptions. The squirrel cage and the squeeze film will also dampen the resonance amplitude and avoid potential instabilities of the LP shaft.

With regard to the exemplary embodiments depicted herein, either a single or multiple gearboxes may be employed, such as a first gearbox between the unducted fan and the ducted fan 40, which may have a reduction ratio of between about 2:1 and 12:1, and a second gearbox between the booster and the ducted fan with a traditional HP turbine. Another configuration may utilize two counter-rotating turbines with two LP shafts 25 coming forward, or counter-rotating turbines may drive a common LP shaft 25 coming forward. In each case, an aft gearbox may have a ratio between about 2:1 and 5:1.

The total desired thrust produced by the gas turbine engine may be varied as needed to suit the operational conditions and flight envelope for the associated aircraft. The maximum design work split between the unducted fan and the ducted fan may also be varied as needed, such as, for example, in certain embodiments up to approximately 60% of the total thrust may be produced by the ducted fan to minimize the engine diameter or noise, while in another embodiment only a few percent of the total thrust if the primary function of the ducted fan stream is as a thermal sink. Pressure ratios for the aft ducted fan may be less than about 2.5.

1. An open rotor propulsion system comprising:
a fan section including an unducted rotating element comprising a first array of fan airfoil blades and a non-rotating stationary element;
a forward frame housing an inlet duct including an inlet located between the unducted rotating element and the non-rotating stationary element;
a ducted fan positioned aft the unducted rotating element within the inlet duct, wherein the ducted fan comprises a second array of fan airfoil blades;
a fan duct and a core duct extending aft the ducted fan;
an engine positioned within the core duct and comprising a low-pressure compressor, a high-pressure compressor, an intermediate case located between the low-pressure compressor and the high-pressure compressor, a fan drive turbine and a shaft connected to the fan drive turbine and configured to drive the ducted fan; and
bearings configured to support the shaft with respect to an engine case, wherein the bearings comprise a double-ball bearing connected to one of the forward frame and the intermediate case.

2. The open rotor propulsion system of claim 1, wherein the double-ball bearing is positioned radially inwardly of the ducted fan.

3. The open rotor propulsion system of claim 1, wherein the double-ball bearing is connected to the forward frame.

4. The open rotor propulsion system of claim 2, wherein a gravity center of the double-ball bearing is axially positioned between a first plane that intersects a forwardmost point of a leading edge of the unducted fan and a second plane that intersects a downwardmost point of a trailing edge of the unducted fan.

5. The open rotor propulsion system of claim 4, wherein the double-ball bearing comprises a forward ball bearing and a downward ball bearing, gravity centers of the forward ball bearing and the forward ball bearing being both axially positioned between the first plane and the second plane.

6. The open rotor propulsion system of claim 1, wherein the double-ball bearing is connected to the intermediate case.

7. The open rotor propulsion system of claim 6, wherein the double-ball bearing is downward of the ducted fan.

8. The open rotor propulsion system of claim 6, wherein a gravity center of the double-ball bearing is axially positioned between a third plane that intersects a forwardmost point of a leading edge of a forwardmost rotor blade of the low-pressure compressor and a fourth plane that intersects a downwardmost point of a trailing edge of a downwardmost rotor blade of the low-pressure compressor.

9. The open rotor propulsion system of claim 8, wherein the double-ball bearing comprises a forward ball bearing and a downward ball bearing, gravity centers of the forward ball bearing and the forward ball bearing being both axially positioned between the third plane and the fourth plane.

10. The open rotor propulsion system of claim 1, wherein the double-ball bearing comprises two ball bearings axially offset by at most 300 mm.

11. The open rotor propulsion system of claim 1, wherein the bearings only comprise the double-ball bearing between a first plane that intersects a forwardmost point of a leading edge of the unducted fan and a fourth plane that intersects a downwardmost point of a trailing edge of a downwardmost rotor blade of the low-pressure compressor.

12. An aircraft comprising at least one open rotor propulsion system according to claim 1, wherein the open rotor propulsion system is connected to the aircraft via a pylon.

13. The open rotor propulsion system of claim 1, wherein the double-ball bearing comprises two ball bearings axially offset by at most 100 mm.
